(19) United States
(12) Patent Application Publication
(10) Pub. No.: US 2008/0028856 A1
(43) Pub. Date: Feb. 7, 2008

(54) CAPACITIVE ACCELERATING SENSOR BONDING SILICON SUBSTRATE AND GLASS SUBSTRATE

(75) Inventors: Katsuya Kikuiri, Niigata-ken (JP); Kiyoshi Sato, Niigata-ken (JP); Tetsuya Fukuda, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD, Tokyo (JP)

(21) Appl. No.: 11/679,638

(22) Filed: Feb. 27, 2007

(30) Foreign Application Priority Data
Aug. 7, 2006 (JP) 2006-214502

(51) Int. Cl. G01P 15/125

(52) U.S. Cl. 73/514.32

(57) ABSTRACT

Provided is a capacitive acceleration sensor including a silicon substrate, which includes a movable electrode having a comb shape and a fixed electrode having a comb shape opposed to the comb shape of the movable electrode, and a pair of glass substrates having a concave portion forming a cavity on at least one side thereof, wherein the silicon substrate and the glass substrates are bonded to each other so that the movable electrode and the fixed electrode is disposed in the cavity. Accordingly, it is possible to provide the capacitive acceleration sensor having a small size and high sensitivity.

This application claims the benefit of priority under 35 U.S.C. §119 to Japanese Patent Application No. 2006-214502, filed Aug. 7, 2006, which is hereby incorporated by reference in its entirety.

### BACKGROUND OF THE INVENTION

1. Field of the Invention

This invention relates to a capacitive accelerating sensor for sensing acceleration by using electrostatic capacitance.

2. Description of the Related Art

A capacitive acceleration sensor is formed by bonding a substrate having an oscillating member, which is a movable electrode, and a substrate having a fixed electrode so as to have a predetermined gap between the oscillating member and the fixed electrode. When acceleration is applied to the oscillating member in the capacitive acceleration sensor, the oscillating member oscillates and the gap between the oscillating member and the fixed electrode varies. Electrostatic capacitance varies between the oscillating member and the fixed electrode in accordance with a variation of the gap. Accordingly, a variation in acceleration is sensed by using the variation of the electrostatic capacitance. The related art is disclosed in JP-A-6-82474.

In addition, in the capacitive acceleration sensor, as the fixed electrode and the movable electrode are formed in a comb-shape by applying the acceleration to the movable electrode, the gap between movable electrode and the fixed electrode varies and the variation of the acceleration is sensed from the variation of the gap. An example of such a capacitive acceleration sensor is disclosed in JP-A-6-82474.

However, since the capacitive acceleration sensor having a related electrode of the comb shape, for example, is made of a surface MEMS (micro electro mechanical systems) which uses silicon, a silicon layer forming the electrode of the comb shape forms a film of polysilicon. Accordingly, since a thickness of the comb shape can not be increased, it is difficult to obtain the capacitive acceleration sensor having high sensitivity. In addition, since the capacitive acceleration sensor is required to be miniaturized, the capacitive acceleration sensor which has a small and has the high sensitivity is required.

### SUMMARY OF THE INVENTION

The present invention is contrived to solve the problem. It is an object of the present invention to provide a capacitive acceleration sensor capable of being a small and having high sensitivity.

According to an aspect of the capacitive acceleration sensor, there is provided a silicon substrate including a movable electrode having a comb shape and a fixed electrode having a comb shape opposed to the comb shape of the movable electrode, and a pair of glass substrates having a concave portion forming a cavity on one at least side thereof, wherein the silicon substrate and the glass substrates are bonded to each other so that the movable electrode and the fixed electrode is disposed in the cavity.

According to the abovementioned configuration, a thickness of the comb shape of the movable electrode or the fixed electrode may be the same as the thickness of the silicon substrate. Accordingly, it is possible to provide the capacitive acceleration sensor having a small size and high sensitivity.

The capacitive acceleration sensor may have a structure obtained by rotating the capacitive acceleration sensor by 90° are stacked or arranged.

In the capacitive acceleration sensor, an extraction electrode of the movable electrode and the fixed electrode may be provided on one substrate of a pair of the glass substrates. According to the configuration, the capacitive acceleration sensor may be formed by a surface mounting or an wire bonding. As a result the capacitive pressure sensor may be made into a chip. At this time, since a casing of the capacitive acceleration sensor is not required, the capacitive acceleration sensor may have a small size.

In the capacitive acceleration sensor, an interface may have an Si—Si bond or an Si—O bond between the glass substrate and the silicon substrate. According to the configuration, since the silicon and the glass are bonded strongly and the interface between the silicon and the glass has a high adhesive property, an airtightness in the cavity can be improved.

According to an another aspect of the capacitive acceleration sensor, there is provided a method of manufacturing a capacitive acceleration sensor, including the steps of manufacturing a silicon substrate including a movable electrode having the comb shape and a fixed electrode having the comb shape opposite to the comb shape of the movable electrode, and bonding the silicon substrate and a pair of glass substrates so that the movable electrode and the fixed electrode are disposed in a cavity by using the pair of glass substrates having a concave portion forming the cavity on one side thereof.

In the capacitive acceleration sensor of the invention, the capacitive acceleration sensor includes a silicon substrate which includes a movable electrode having the comb shape and a fixed electrode having the comb shape opposed to the comb shape of the movable electrode, and a pair of glass substrates having a concave portion forming a cavity on at least one side thereof, wherein the silicon substrate and the glass substrates are bonded to each other so that the movable electrode and the fixed electrode is disposed in the cavity. Accordingly, it is possible to provide the capacitive acceleration sensor having a small size and the high sensitivity

### BRIEF DESCRIPTION OF THE DRAWINGS

FIGS. 1A to 1B are a diagram illustrating a capacitive acceleration sensor according to an embodiment of the invention, where FIG. 1A is a perspective view and FIG. 1B is a sectional view.

FIGS. 2A to 2C are sectional views illustrating a method of manufacturing a capacitive acceleration sensor according to the embodiment of the invention.

FIGS. 3A to 3E are sectional views illustrating a method of manufacturing a capacitive acceleration sensor according to the embodiment of the invention,

FIGS. 4A to 4E are sectional views illustrating a method of manufacturing a capacitive acceleration sensor according to the embodiment of the invention.

### DESCRIPTION OF THE PREFERRED EMBODIMENTS

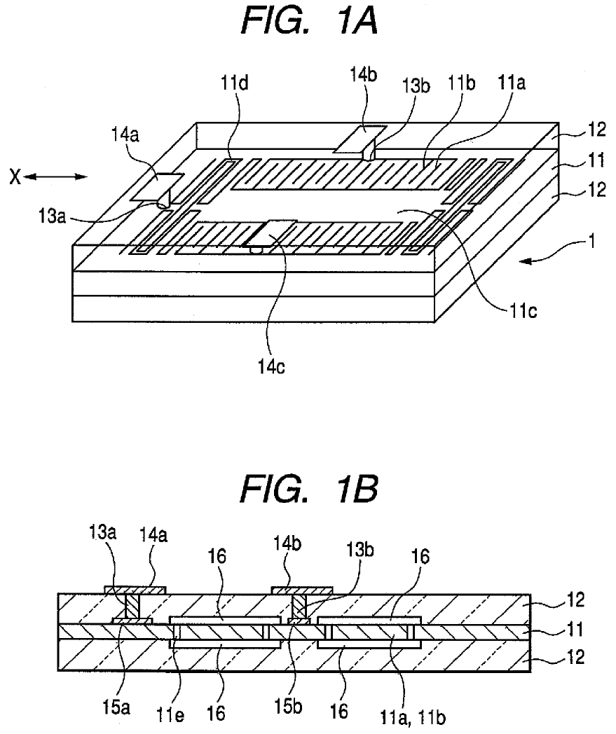

Hereinafter, an embodiment of the invention will be described with accompanying drawings, FIGS. 1A to 1B are diagrams illustrating a capacitive acceleration sensor according to the embodiment of the invention, where FIG. 1A is a perspective view and FIG. 1B is a sectional view.

As shown in FIG. 1A, the capacitive acceleration sensor 1 is mainly formed of a silicon substrate 11, which is a first substrate having a movable electrode 11a and a fixed electrode 11b, and a pair of second substrates which are a glass substrate 12, and are disposed so that the silicon substrate 11 is interposed between the glass substrates 12.

The movable electrode 11a includes a spindle portion 11c and the comb shape extending from the spindle portion 11c to a Y direction of FIG. 1A. In addition, the spindle portion 11c extends from through the silicon substrate 11 to the spring portion 11d. The spring portion 11d is formed of expandable material in an X-direction of FIG. 1A.

The fixed electrode 11b includes the comb shape which is likely to oppose to the comb shapes of the movable electrode 11a. Accordingly, the comb shapes of the fixed electrode 11b are provided so as to extend between the comb shapes of the movable electrode 11a. In addition, a predetermined capacitance is emitted between both combs by opposing the comb shapes of the movable electrode 11a and the comb shapes of the fixed electrode 11b. Herein, since the movable electrode 11a, the fixed electrode 11b, the spindle portion 11c, and the spring portion 11d are formed by a process for the silicon substrate 11, a thickness of the movable electrode 11a, the fixed electrode 11b, the spindle portion 11c, and the spring portion 11d have the substantially same thickness as the thickness of the silicon substrate 11. However, other modifications of the thickness of the movable electrode 11a, the fixed electrode 11b, the spindle portion 11c, and the spring portion 11d may vary without departing from the scope of the objection of the present invention. Accordingly, since the thickness of the movable electrode 11a and the fixed electrode 11b may be the same as the thickness of the silicon substrate, an opposed area between the comb shapes of the movable electrode 11a and the comb shapes of the fixed electrode 11b can be increased. Accordingly, it is possible to provide the capacitive acceleration sensor having the high sensitivity.

The movable electrode 11a is electrically connected to an extraction electrode 14a provided on the glass substrate 12 of the one side through a connection member 13a. In addition, the fixed electrode 11b is electrically connected to an extraction electrode 14b and an extraction electrode 14c provided on the substrate 12 of the other side through a connection member 13b.

As shown in FIG. 1B, the one main surface of the silicon substrate 11 is connected to on the one glass substrate 12 and the other glass substrate 12 is connected to on the other main surface of the silicon substrate 11, The glass substrate 12 includes a concave portion forming a cavity and the movable electrode 11a, the fixed electrode 11b, the spindle portion 11c and the spring portion 11d are disposed in a cavity 16 which is formed by bonding the glass substrate 12 and the silicon substrate 11. Accordingly, a position of the concave portion formed in the glass substrate 12 is properly determined by the movable electrode 11a, the fixed electrode 11b, the spindle portion 11c, and the spring portion 11d in the silicon substrate 11. Although as shown in FIG. 1B, it is described when each concave portion is formed as a pair of the glass substrates 12 respectively. However, in the present invention, when the movable electrode 11a, the spindle portion 11c, and the spring portion 11d are movable, the concave portion may be provided to the one glass substrate 12.

In the silicon substrate 11, a space portion 11e is provided so as to operate the movable electrode 11a. The comb shape may move in the space portion 11e.

In the glass substrate 12 of an upper side, a structure in which the movable electrode 11a or the fixed electrode 11b in the silicon substrate 11 is extracted to a surface of the glass substrate 12 is provided. That is, the concave portion is formed on the silicon substrate 11 side of the glass substrate 12 of the upper side, a contact layer 15a connecting the movable electrode 11a electrically and a contact layer 15b connecting the fixed electrode 11b electrically are formed in the concave portion. For example, the contact layer 15a, 15b is made of gold-silicon eutectic material, and the like.

A through hole is formed in the concave portion of the substrate 12 of the upper side and the connection member 13a and the connection member 13b are buried in the through hole. In addition, the connection member 13a, 13b are exposed in an upper surface of the glass substrate 12 of the each upper side and are connected electrically to the extraction electrodes 14a, 14b, and 14c. Accordingly, the movable electrode 11a is electrically connected to the extraction electrode 14a provided in a surface of the glass substrate 12 through the contact layer 15 and the connection member 13a. The fixed electrode 11b is connected electrically to the extraction electrode 14b and 14c provided in a surface of the glass substrate 12 through the contact layer 15b and the connection member 13b. In the capacitive acceleration sensor, it is possible that a surface mounting or a wire bonding is performed by providing the extraction electrode for the movable electrode and the extraction electrode for the fixed electrode to a surface of the one glass substrate. As a result, it is possible that the capacitive acceleration sensor is made into a chip. At this time, since a casing of the capacitive acceleration is not required, a miniaturization of the capacitive acceleration sensor can be possible.

It is preferable that the interface between the silicon substrate 11 and the glass substrate 12 has a high adhesive property. When the silicon substrate 11 is bonded to the glass substrate 12, the adhesive property of the substrate 11 and the substrate 12 can be improved by mounting the silicon substrate 11 on a bonding surface of the glass substrate 12 and performing a process of an anodic bonding. Accordingly, since the interface of the glass substrate 12 and the silicon substrate 11 exhibit the high adhesive property, an airtightness in the cavity 16 can be increased. Accordingly, since a movable member, such as the movable electrode in the cavity 16, is not affected by viscous resistance of air by improving the airtightness in the cavity 16, the high sensitivity is emitted about accelerated velocity.

Herein, the anodic bonding refers to a process in which high electrostatic attraction is emitted in a predetermined temperature (e.g. below 400° C.) by applying a predetermined voltage, and a chemical bond is formed through oxygen in a contacted glass-silicon interface or a covalent bond is performed by emission of oxygen. The covalent bond in the interface is an Si—Si bond between Si atom which is included in Si atom of silicon and glass or an Si—O bond. Accordingly, the silicon and the glass are bonded strongly by the Si—Si bond or the Si—O bond and the high adhesive property may be exhibited in the interface between the silicon and the glass. To efficiently perform the anodic bonding, it is preferable that material of the glass substrate 12a is glass material (e.g. Pyrex glass (Registered Trade mark of Corning Corporation)) including alkali metal, such as sodium and the like.

The capacitive acceleration sensor having such a configuration includes a predetermined electrostatic capacitance between the comb shape of the movable electrode 11a and the comb shape of the fixed electrode 11d. When acceleration is applied to the acceleration sensor, the movable electrode 11a is displaced in response to the acceleration. At this time, the electrostatic capacitance between the comb shape of the movable electrode 11a and the fixed electrode 11b. Accordingly, the electrostatic capacitance is a parameter and the variation may be the variation of the acceleration. In addition, according to the configuration, a thickness of the comb shape of the movable electrode 11a and the fixed electrode 11b may be the same as the thickness of the silicon substrate 11. Accordingly, it is possible to provide the acceleration sensor having the high sensitivity.

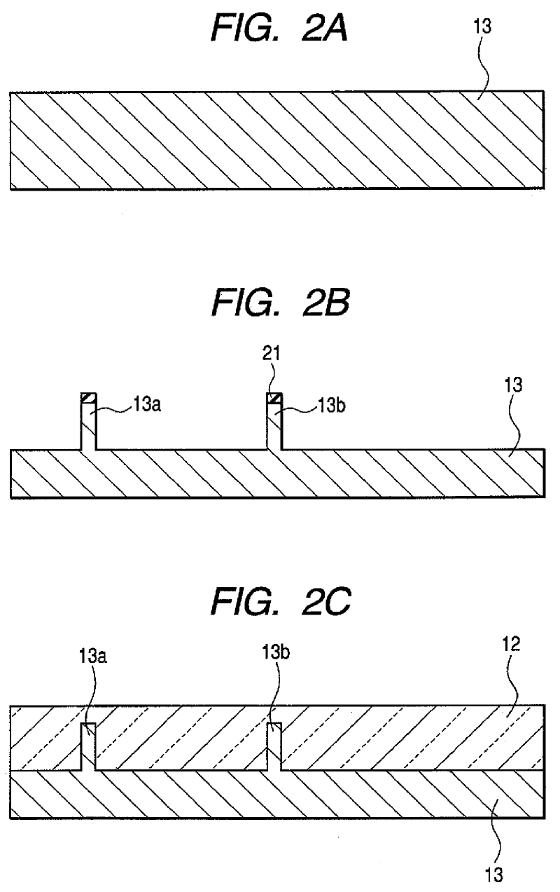

Next, a method of manufacturing the capacitive acceleration sensor will be described according to the embodiment. FIGS. 2A to 2C, FIGS. 3A to 3E, and FIGS. 4A to 4E are sectional views illustrating the manufacturing method of the capacitive acceleration sensor according to the embodiment of the invention.

At the time of manufacturing the capacitive acceleration sensor according to the embodiment of the invention, the capacitive acceleration sensor includes a silicon substrate, which has a movable electrode having the comb shape and a fixed electrode having the comb shape opposed to the comb shape of the movable electrode, and a pair of glass substrates having a concave portion forming a cavity on at least one side thereof, wherein the silicon substrate and the glass substrates are bonded to each other so that the movable electrode and the fixed electrode is disposed in the cavity. At this time) the silicon substrate and the glass substrate may be bonded each other after forming the movable electrode and the fixed electrode on the silicon substrate or the movable electrode and the fixed electrode may be formed on the silicon substrate or after bonding the silicon substrate to the glass substrate.

Firstly, as shown in FIG. 2A, a silicon substrate 13 is provided, which is made by doping impurities and having a low resistance. The impurities may be n-type impurities or p-type impurities. A resistance rate is 0.01 Ω·cm. In addition, as shown in FIG. 2B, the connection members 13a, 13b are formed by etching a one main surface of the silicon substrate 13. At this time, a resist film 21 is formed on the silicon substrate 13, the resist film is patterned (photolithography) so that the resist film is remained on the formation area of the connection member 13a, 13b, and the resist film is etched as a mask. Then, a remaining resist film is removed. Accordingly, the connection member 13a and the connection member 13b are provided. In addition, a deep RIE (Reactive Ion Etching) is used as an etching method.

Next, as shown in FIG. 2C, the glass substrate 12 (an upper glass substrate as shown in FIG. 1B) is disposed on the silicon substrate 13 in which the connection member 13a and the connection member 13b are formed, the silicon substrate 13 and the glass substrate 12 are heated under vacuum, the silicon substrate 13 is pressed into the glass substrate 12, the connection member 13a and the connection member 13b are pushed into the glass substrate 12, and the silicon substrate 13 and the glass substrate 12 are bonded with each other. At this time, it is preferable that a temperature is below a melting point of the silicon and the temperature may vary (i.e. below the melting pong of the glass). For example, the heating temperature is about 800° C.

In addition, it is preferable that the anodic bonding is performed so as to improving the adhesive property of the interface between the connection member 13a, 13b and the glass substrate 12 of the silicon substrate 13. At this time, the electrode is attached to the silicon substrate 13 and the glass substrate 12 respectively, by heating the silicon substrate 13 and the glass substrate 12 under 400° C. and by applying a voltage about from 300 V to 1 KV. According to the above-mentioned process, since the adhesive property of the interface between the silicon substrate and the glass substrate can be improved, the airtightness of the cavity 16 of the capacitive acceleration sensor can be improved.

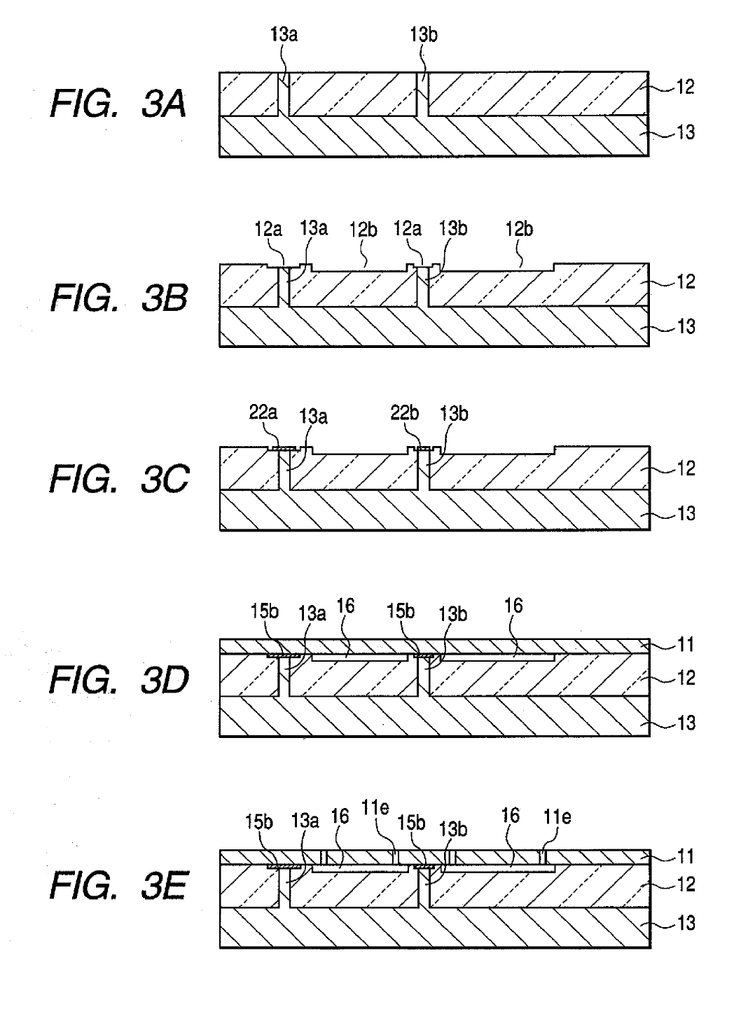

Continuously, as shown in FIG. 3A, the connection member 13a, 13b of the silicon substrate 13 may be exposed by grinding (lap process) the one main surface of the glass substrate 12. In addition, a polishing process is performed on the bonding surface of the glass substrate 12. Accordingly, as shown in FIG. 3B, for example, a milling process is performed in the glass substrate 12 and the connection member 13a, 13b. Accordingly, a concave portion 12a for a contact layer and a concave portion for 12b are formed. The milling process is performed in the concave portion 12b for the cavity and a depth of the concave portion increases.

In addition, as shown in FIG. 3C, contact seed layers 22a, 22b are formed in the concave portion 12a of the glass substrate 12. At this time, the resist film is bonded on the glass substrate 12, and the resist film is patterned so that a formation area of the contact seed layer is open. The materials forming the contact seed layer 22a, 22b are formed by the sputtering method, and the resist film is removed (lifted off). Herein, a gold layer is used as the contact seed layer.

Continuously, as shown in FIG. 3D, the silicon substrate 1, which is formed on the contact seed layer 22a, 22b by etching and grinding in a predetermined thickness of several tens of micrometers (a desirable thickness of the comb shape), is formed on the glass substrate 12. At this time, the anodic bonding is performed about the silicon substrate 11 and the glass substrate 12 by applying about 500 V and heating the silicon substrate 11 and the glass substrate 12 under 400° C. According to the process, since the adhesive property between the silicon substrate 11 and the glass substrate 12 is improved, the airtightness of the cavity 16 can be improved. At this time, the gold of the contact seed layers 22a, 22b reacts in a gold-silicon eutectic process with the silicon of the silicon substrate 11, and the gold-silicon eutectic material may be obtained, and a contact layer 15a and the contact layer 15b are formed. Accordingly, a cavity 16 is formed between the concave portion 12b of the glass substrate 12 the silicon substrate 11.

In addition, as shown in FIG. 3E, a pattern including the movable electrode 11a, the fixed electrode, the spindle portion 11c, and the spring portion 11d are formed in the silicon substrate 11. At this time, the pattern is formed in the silicon substrate 11 by the deep RIE by using a mask having the pattern. Accordingly, since the etching is performed more deeply than the usual etching by performing the process in the silicon substrate 11, a thickness of the spindle portion 11c can increase and weight of the spindle portion 11c can increase. As a result, it is possible to provide the capacitive acceleration sensor having the high sensitivity.

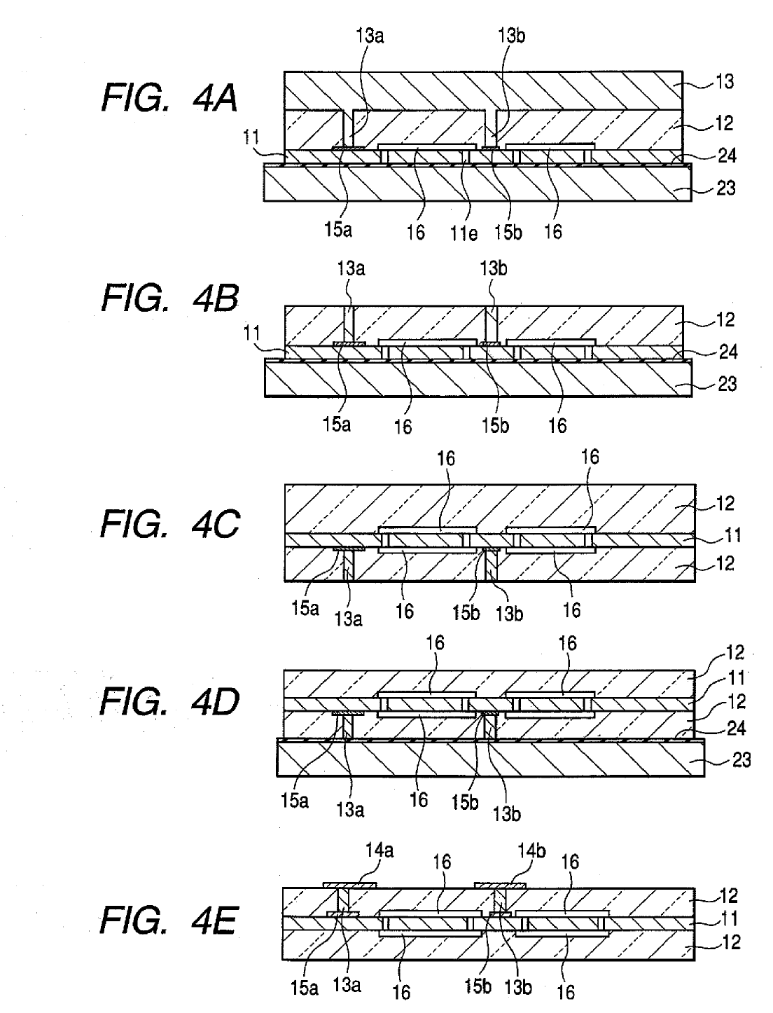

In addition, as shown in FIG. 4A, a surface of the silicon substrate 11, which does not bond the glass substrate 12, is fixed on a base material 23 with an adhesive. Next, as shown in FIG. 4B, the connection member 13a and the connection member 13b are exposed by performing the grinding process and the lap processing of the silicon substrate 13 is performed. Accordingly, as shown in FIG. 4C, the base material 23 is removed and the glass substrate 12 of the silicon substrate 11 is bonded to the glass substrate 12, which is not bonded (a lower glass substrate as shown in FIG. 1B). In addition, the concave portion for the cavity is formed in the glass substrate. At this time, the anodic bonding is performed about the silicon substrate 11 and the glass substrate 12 by heating the silicon substrate 11 and the glass substrate 12 under 400° C. applying the voltage of 500 v. Accordingly, since the adhesive property of the interface between the silicon substrate 11 and the glass substrate 12 can be improved, the airtightness of the cavity 16 can be improved. Accordingly, a cavity 16 between the concave portion 12b of the glass substrate 12 and the silicon substrate 11 can be formed. In addition, the movable electrode 11a, the fixed electrode 11b, the spindle portion 11c, and the spring portion 11d are disposed in the cavity 16.

In addition, as shown in FIG. 4D, the grinding process of both surfaces of the glass substrate in which the connection member 13a and the connection member 13b are buried, is performed. At this time, the glass substrate 12 is fixed by using the adhesive 24, and the grinding process is performed. Accordingly, as shown in FIG. 4E, the extraction electrode 14a and the extraction electrode 14b are formed the connection member 13a, 13b which is exposed on the surface of the glass substrate 12. At this time, a seed layer is formed on the connection member 13a, 13b by the sputter method and the extraction electrodes 14a, 14b, 14c are formed on the glass substrate 12 by plating. Also, a condition of the plating is the generally used condition although the condition may be varied according to the material.

In the capacitive acceleration sensor according to the above-mention process, the movable electrode 11a is electrically connected to the extraction electrode 14a through the contact layer 15a and the connection member 13a, and the fixed electrode 11b is electrically connected to the extraction electrodes 14b, 14c through the contact layer 15b and connection member 13b. Accordingly, a signal which is sensed between the combs of the movable electrode 11a and the comb shape of the fixed electrode 11b can be obtained from the extraction electrodes 14a, 14b, and 14c. Consequently, a electrostatic capacitance C₁, which is sensed between the extraction electrode 14a of the movable electrode 11a and the extraction electrode 14b of the fixed electrode 11b, can be obtained, and a electrostatic capacitance C₂, which is sensed between the extraction electrode 14a of the movable electrode 11a and the extraction electrode 14a of the movable electrode 11a, can be obtained. Accordingly, a ratio (C₁/C₂) of the electrostatic capacitance can be obtained. A calculated acceleration can be obtained in accordance with the electrostatic capacitance.

In the capacitive acceleration sensor, a thickness of the movable electrode 11a or the fixed electrode 11b may be the same as the thickness of the silicon substrate 11. Accordingly, it is possible to provide the acceleration sensor having the high sensitivity. In addition, since in the capacitive acceleration sensor, the movable electrode 11a and the fixed electrode 11b are disposed in the cavity 16 having the high airtightness by the bonding between the silicon substrate and the glass substrate, the capacitive acceleration sensor exhibits a property of several hundred times a Q value, and it is possible to provide the capacitive acceleration sensor having a high sensitivity. In addition, in the invention, since the comb shape is provided in the silicon substrate 11 by the deep RIE, a relatively thick comb shape can be easily provided and the capacitive acceleration sensor having the high sensitivity can be easily and simply obtained.

The invention is not limited to the above-mentioned embodiments and various modifications and variations may be made. For example, in a structure as shown in FIG. 1A, the movable electrode and the spindle portion is made of expandable material and may sense a component of an x-axis direction. When the capacitive acceleration sensor senses a component of an y-axis direction, the structure of FIG. 1A is obtained by rotating the capacitive acceleration sensor by 90°. Accordingly, since the movable electrode or the spindle portion is made of the expandable material in an y-axis direction, the component of the y-axis direction may be sensed. In addition, the structure of FIG. 1A and the structure which is obtained by rotating the structure of FIG. 1A by 90° are stacked or arranged so as to sense the component of the x-axis direction and the y-axis direction.

In the capacitive acceleration sensor of the invention, the structure and the shape of the movable electrode, the fixed electrode, the spindle portion, and the spring portion are not limited to the exemplary embodiment, but may be modified in various forms without departing from the object of the invention. In addition, in the embodiment, the explained figure or the material are not limited to the exemplary embodiments, In addition, the condition of the process of the etching and the milling are generally used condition. In addition, the process explained in the embodiment is not limited to the exemplary embodiment and may be performed with exchanging properly an order in the process. The invention is not limited to the exemplary embodiments, but may be modified in various forms without departing from the gist of the invention.

What is claimed is:

1. A capacitive acceleration sensor comprising:
a silicon substrate including a movable electrode having a comb shape and a fixed electrode having a comb shape opposed to the comb shape of the movable electrode; and
a pair of glass substrates having a concave portion forming a cavity on at least one side thereof,
wherein the silicon substrate and the glass substrates are bonded to each other so that the movable electrode and the fixed electrode are disposed in the cavity.

2. A capacitive acceleration sensor, wherein the capacitive acceleration sensor according to claim 1 and a capacitive acceleration sensor having a structure obtained by rotating the capacitive acceleration sensor by 90° are stacked or arranged.

3. The capacitive acceleration sensor according to claim 1, wherein extraction electrodes for the movable electrode and the fixed electrode are provided on one substrate of the pair of glass substrates.

4. The capacitive acceleration sensor according to claim 1, wherein an interface between the glass substrates and the silicon substrate has an Si—Si bond.

5. A method of manufacturing a capacitive acceleration sensor, the method comprising:
manufacturing a silicon substrate including a movable electrode having a comb shape and a fixed electrode having a comb shape opposed to the comb shape of the movable electrode; and
bonding the silicon substrate and a pair of glass substrates so that the movable electrode and the fixed electrode are disposed in a cavity by using the pair of glass substrates having a concave portion forming the cavity on at least one side thereof.

6. The method according to claim 5, wherein bonding the silicon substrate and the glass substrates forms an interface between the glass substrates, and the silicon substrate has an Si—Si bond.

7. The capacitive acceleration sensor according to claim 1, wherein an interface between the glass substrates and the silicon substrate has an Si—O bond.

8. The method according to claim 5, wherein bonding the silicon substrate and the glass substrates forms an interface between the glass substrates, and the silicon substrate has an Si—O bond.
